(19) United States
(12) Patent Application Publication
(10) Pub. No.: US 2024/0210551 A1
(43) Pub. Date: Jun. 27, 2024

(54) METHOD FOR TRANSFERRING INFORMATION VIA A MOBILE BEACON

(71) Applicant: APITRAK SAS, MEYLAN (FR)

(72) Inventors: Luc ANTOLINOS, MEYLAN (FR); Julien BONNAL, MEYLAN (FR); Yoni POMARES, MEYLAN (FR); Frédéric MARTIN, MEYLAN (FR)

(21) Appl. No.: 18/555,455

(22) PCT Filed: Apr. 15, 2022
(86) PCT No.: PCT/EP2022/060177

§ 371 Date: Oct. 13, 2023

(30) Foreign Application Priority Data
Apr. 16, 2021 (FR) 2103948

(51) Int. Cl. G01S 13/87; G01S 5/02; G01S 5/14

(52) U.S. Cl. CPC G01S 13/878; G01S 5/0268; G01S 5/14

(57) ABSTRACT

A method for transmitting a piece of information from at least one first UWB radio tag by a mobile beacon including transmission and a receiver, includes transmitting a first energizing signal by a transmitter of the mobile beacon; receiving, by the mobile beacon by a UWB receiver, a first UWB signal of at least the first UWB radio tag energized by the first UHF signal; determining a first position piece of data of the mobile beacon by a location system, recording a first decoded tag piece of data of the first received UWB signal in a memory of the mobile beacon.

The field of the invention relates to the field of methods for transmitting at least one piece of information by means of a communication interface. The field of the invention is more particularly concerned with the field of methods for transmitting one or more data transmitted by a radio tag. Finally, the field of the invention is more specifically concerned with the field of methods for transmitting, by means of a mobile beacon, a location piece of data and at least one piece of data transmitted by a UWB (Ultra-Wide Band) radio tag.

In prior art, different solutions exist to ensure transmission of a piece of data of a UWB signal received. By way of example, application EP3680687 describes a method for determining the location of a UWB tag using a signal exchanged between a fixed beacon and the UWB tag and a method for adapting the signal exchanged according to the position of the UWB tag.

However, a problem persists, on the one hand when the implementation of a fixed detection infrastructure proves unsuitable for the environment or when the UWB tags are located in so-called “shadow zones”, which are zones hidden or remote from the detection infrastructure and in which UWB tags cannot be correctly detected or energized. In this respect, there is a real need to implement a solution allowing detection of UWB signals of tags positioned in these ‘shadow zones’. There is also a need to implement a UWB signal detection solution in environments where the implementation of a fixed infrastructure is not suitable, for example for reasons of financial costs or because arrangement restrictions do not allow this.

The invention detailed below solves the above drawbacks by providing a mobile UHF (Ultra-High Frequency) energy supply and UWB signal detection solution.

### SUMMARY OF THE INVENTION

According to a first aspect, the invention relates to a method for transmitting a piece of information of at least one first UWB radio tag by means of a mobile beacon comprising transmission and reception means, characterized in that it comprises:
Transmitting a first energizing signal by means of a transmitter of an energizing signal of the mobile beacon;
Receiving, by the mobile beacon by means of a UWB receiver, a first UWB signal of at least the first UWB radio tag energized by the first energizing signal;
Recording a first decoded tag piece of data from the first UWB signal received in a memory of the mobile beacon;
Timestamping said reception of the first UWB signal to produce a first timestamping piece of data associated with the first piece of data;
Determining a first position of said mobile beacon by means of a location system;
Associating the first position piece of data of the mobile beacon with said first tag piece of data, said position piece of data making it possible to locate said mobile beacon,
Transmitting a first piece of information by the mobile beacon comprising said first tag piece of data and the first timestamping piece of data and transmitting a second piece of information by the mobile beacon comprising the first position piece of data to at least one piece of equipment of a data network.

One advantage is to be able to retrieve and transmit, for example within a data server, different information associated with a radio tag, to identify said radio tag or to associate position of the radio tag with position of the mobile beacon. Another advantage is to be able to use a UHF source to energize a radio tag located in a shadow zone which cannot be detected by a fixed infrastructure.

According to one example, the first energizing signal is a UHF signal and the transmitter of the energizing signal of the mobile beacon is a UHF transmitter.

According to one embodiment, the first piece of information is transmitted to a data server via a Wi-Fi, 4G, 5G or Bluetooth link and the second piece of information is transmitted in the form of a UWB message to a location system including at least one fixed beacon comprising means for receiving UWB signals to calculate the position of the mobile beacon by trilateration, said association between the first position piece of data of the mobile beacon and said first tag piece of data being performed by a data server and making it possible to locate said mobile beacon.

One advantage is to be able to rely on the presence of a fixed UWB detection infrastructure to calculate an accurate position of the mobile beacon in the environment.

According to one embodiment, the method comprises:
Transmitting a second UWB signal by the mobile beacon by means of a UWB transmitter including at least one identification piece of data of said mobile beacon encoded in said second UWB signal;
Receiving the second UWB signal by the location system including a plurality of UWB radio beacons including radio reception means and means for decoding a piece of information and time stamping the arrival of said second UWB signal;
Transmitting a detection piece of information of the second UWB signal to the mobile beacon,
Calculating, using all the second signals received by each of the radio beacons, a position of the mobile beacon.

One advantage is to be able to ensure that a UWB signal transmitted by the mobile beacon is actually detected by a plurality of beacons of the infrastructure.

According to one embodiment, the method comprises:
transmitting a plurality of second UWB signals by the mobile beacon by means of a UWB transmitter, each second UWB signal including at least one encoded piece of data for identifying said mobile beacon;
receiving the second UWB signals by the location system including a plurality of UWB radio beacons, said location system comprising radio reception means and means for decoding the identification piece of data and for time stamping arrival of the second UWB signals;
transmitting, to the mobile beacon by the location system, a piece of information of detecting the second UWB signal;
calculating, by means of a plurality of second signals received by each of the radio beacons, the first position piece of data of the mobile beacon.

According to one embodiment, the method comprises:
Transmitting the second UWB signal by the mobile beacon including at least one identification piece of data of said mobile beacon encoded in said second UWB signal, said transmitting automatically generating transmitting the detection piece of information by a UWB system when the latter receives said identification piece of data,
Transmitting a plurality of second UWB signals at an increased frequency during a second time interval in case of non-reception of the detection piece of information at the end of a first time interval.

According to one embodiment, the method comprises:
transmitting a second UWB signal by the mobile beacon by means of a UWB transmitter, said second UWB signal comprising at least one encoded piece of data of identifying said mobile beacon, said transmitting resulting in activating a clock to measure a first time interval,
transmitting a plurality of second UWB signals at an increased frequency during a second time interval in case of non-reception of a detection piece of information at the end of a first time interval, said detection piece of information indicating detection of the second UWB signal by a UWB reception system.

One advantage is to ensure that the mobile beacon is actually detected by the detection infrastructure when the first UWB signal transmitted has not allowed said detection of the mobile beacon.

According to one embodiment, the first piece of information and the second piece of information are transmitted to a data server by a wireless communication interface, the association between the first position piece of data of the mobile beacon and the first tag piece of data being performed within the mobile beacon, said first position piece of data being transmitted to the mobile beacon by a location system.

One advantage is to be able to associate position of the mobile beacon with position of a UWB tag originating transmitting a UWB signal comprising the first tag piece of data.

According to one embodiment, the first position piece of data is transmitted by:
A reference tag having known position;
A satellite geolocation system;
A geolocation system by geocoder;
A Wi-Fi geolocation system;
A geolocation system by use of a telecommunications operator,
An RFID geolocation system.

One advantage is to be able to adapt the location system to the context in which the mobile beacon operates. For example, a location system comprising a reference tag will be more suitable in an indoor environment than satellite geolocation.

Optionally, the mobile beacon B_{M} receives the first position piece of data.

According to one embodiment, the method comprises:
Transmitting a third UWB signal comprising a first time piece of information and a second piece of information by at least one UWB radio tag with a known position reference;
Receiving the third UWB signal by the mobile beacon;
Recording the first time piece of information and the second piece of data decoded from the UWB signal received in a memory of the mobile beacon;
Timestamping said reception of the third UWB signal to produce a second timestamping piece of data associated with receiving the time piece of information and the second piece of data,
Transmitting a third piece of information comprising the first time piece of information, the second piece of data and the second timestamping piece of data to at least one piece of equipment in the data network.

One advantage is to be able to calculate a travel time of a UWB signal between a reference tag having known position and the mobile beacon.

According to one embodiment, the method comprises:
receiving, by the mobile beacon and by means of a UWB receiver, a third UWB signal transmitted by at least one reference UWB radio tag having known position, said third UWB signal comprising a first encoded time piece of information of time stamping the transmission of said third UWB signal and comprising a second encoded identification piece of data of the reference UWB radio tag;
time-stamping said reception of the third UWB signal to produce a second piece of data of timestamping reception of the time piece of information and the second piece of data,
recording the first decoded time piece of information and the second decoded identification piece of data in a memory of the mobile beacon;
transmitting, by the mobile beacon, a third piece of information comprising the first time piece of information, the second piece of data and the second timestamping piece of data to at least one piece of equipment of the data network.

According to one embodiment, the method comprises:
Transmitting, by the mobile beacon and by a plurality of UWB radio beacons, a plurality of third pieces of information each comprising the first time piece of information, the second piece of data and a timestamping piece of data by means of a communication interface to at least one piece of equipment of the data network;
Determining for the mobile beacon and for each UWB radio beacon a propagation time piece of information of each third UWB signal, said propagation time piece of information being determined on the basis of the first time piece of information and the timestamping piece of data;
Comparing the propagation time information of each third UWB signal by means of a comparator,
Synchronizing the clocks of the mobile beacon and the UWB radio beacons with each other according to the propagation time information of each third UWB signal

One advantage is to synchronize clocks of a plurality of mobile or fixed beacons to allow implementation of position calculations by trilateration.

According to one embodiment, the method comprises:
transmitting, by the mobile beacon and by a plurality of UWB radio beacons, a plurality of third pieces of information via a communication interface and to at least one piece of equipment of the data network;
calculating, for the mobile beacon and for each UWB radio beacon and by means of a calculator, a propagation time piece of information of each third UWB signal, each propagation time piece of information being calculated from each first time piece of information and each second timestamping piece of data;
comparing, by a comparator, the propagation time information of each third UWB signal,
synchronizing a clock of the mobile beacon and a clock of each UWB radio beacon between them according to the result of comparisons of the propagation time information.

According to one embodiment, the method comprises implementing at least one calculation of a relative position of at least the first UWB radio tag per trilateration, said calculation being implemented by means of a calculator on the basis of at least one first UWB signal transmitted by the first UWB radio tag and received by the mobile beacon and by at least two UWB radio beacons.

According to one embodiment, the method comprises implementing, by means of a calculator, at least one calculation by trilateration of a relative position of the first UWB radio tag, from the first UWB signal transmitted by said first UWB radio tag and received by the mobile beacon and by at least two other UWB radio beacons.

One advantage is to use the mobile beacon to perform at least one calculation of a position of an object by trilateration when the position of said mobile beacon is known.

According to one embodiment, the method comprises
Receiving a first amount of UHF energy by the mobile beacon by means of a UHF receiver;
Comparing, by means of a comparator, the first amount of UHF energy received with a predetermined threshold energy value;
Transmitting the first energizing UHF signal using the UHF transmitter by the mobile beacon if the first amount of UHF energy received is below the predetermined threshold energy value,
Reducing the energy transmitted by the UHF transmitter of the mobile beacon if the first amount of UHF energy received exceeds the predetermined threshold energy value.

One advantage is to be able to “map” the UHF energy of several zones and supply the weakest supplied zones with UHF energy. Advantageously, transmitting the first UHF signal may result in transmitting UWB signals by tags present in the initially low-energized zone.

According to one embodiment, the method comprises:
Measuring a distance value between an object and the mobile beacon by means of a distance sensor;
Comparing the distance value measured with a predetermined threshold distance value,
Modulating transmission of the first UHF energizing signal by the UHF transmitter of the mobile beacon if the distance value measured is below the predetermined threshold distance value.

Advantageously, overall energy consumption can be reduced by reducing the transmitted signal power when the UHF energy supply source is close to a UWB radio tag to be energized.

According to one embodiment, the first UWB signal received is associated with a context piece of information, said context piece of information being processed by processing means to determine an identification piece of data of at least one mobile beacon having transmitted a first UHF energizing signal originating the transmission by the first UWB radio tag of said first UWB signal received by the mobile beacon.

According to one embodiment, the first UWB signal received by the mobile beacon is associated with a context piece of information corresponding to a piece of information on the environment in which the mobile beacon operates, and in which the first piece of information transmitted to the equipment of a data network comprises the context piece of information, the context piece of information being processed by processing means to determine an identification piece of data of the mobile beacon having transmitted the first energizing signal originating transmission by the first UWB radio tag of said first UWB signal received by said mobile beacon.

One advantage is to be able to precisely identify a mobile beacon according to different physical parameters measured, for example, by means of sensors.

According to another aspect, the invention relates to a mobile beacon comprising transmission and reception means configured to implement the method according to any of the aforementioned embodiments.

According to another aspect, the invention relates to a mobile beacon comprising means for transmitting an energizing signal, means for receiving UWB signals, a calculator, and a memory, and configured to implement the method according to any of the aforementioned embodiments.

According to one embodiment, the mobile beacon comprises at least two transmission antennas, each transmission antenna being configured to transmit at least one portion of the first energizing UHF signal. One advantage is to be able to supply a plurality of radio tags, each located at different positions, with UHF energy. Another advantage is to increase the UHF coverage of the mobile beacon when controlling directionality of the UHF beam is made difficult by the hardware configuration, for example when the mobile beacon is mounted to a mobile cart.

According to another aspect, the invention relates to a mobile cart including a mobile beacon according to any of the aforementioned embodiments.

According to another aspect, the invention relates to an element embedded by a user comprising a mobile beacon.

According to another aspect, the invention relates to a system comprising a mobile beacon according to any of the aforementioned embodiments and including at least one first UWB radio tag.

Optionally, the first radio tag is configured to transmit the first UWB signal.

### BRIEF DESCRIPTION OF THE FIGURES

Other characteristics and advantages of the invention will become clearer upon reading the following detailed description, in reference to the appended figures, that illustrate:

FIG. 1: A flowchart of the method according to the invention when it comprises storing a first piece of data in a memory of the mobile beacon.

FIG. 2: A flowchart of the method according to the invention when it comprises transmitting a plurality of pieces of information to a piece of equipment of a data network.

FIG. 3: A flowchart of the method according to the invention when it comprises receiving a detection piece of information by the mobile beacon.

FIG. 4: A flowchart of the method according to the invention when it comprises transmitting a plurality of UWB signals at an increased frequency.

FIG. 5: A flowchart of the method according to the invention when it comprises receiving a UWB signal transmitted by a reference tag.

FIG. 6: A flowchart of the method according to the invention when it comprises comparing an amount of UHF energy with a threshold energy value.

FIG. 7: A flowchart of the method according to the invention when it comprises comparing a distance value with a threshold distance value.

FIG. 8: A schematic diagram of a mobile cart comprising a mobile beacon.

FIG. 9: An illustration of the mobile beacon when embedded by a user.

### DETAILED DESCRIPTION

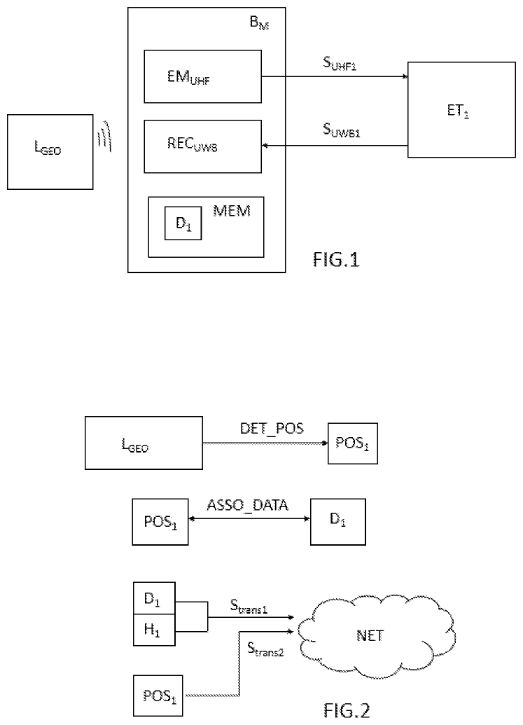

FIG. 1 describes a method for transmitting a piece of information of at least one first radio tag UWB by means of a mobile beacon B_{M} according to a first aspect of the invention when the mobile beacon B_{M} comprises transmission and reception means.

### UHF Transmitter of the Mobile Beacon

According to one embodiment, the mobile beacon B_{M} comprises an energy transmitter. The energy transmitter is, for example, a UHF (ultra-high frequency) transmitter EM_{UHF}. In the remainder of the description, the energy transmitter of the mobile beacon B_{M} will be described with the example of a UHF transmitter. However, any type of transmitter intended to provide energy at various frequencies to supply a receiver is likely to be implemented within the scope of the invention. The UHF transmitter EM_{UHF} is configured to transmit a first energizing UHF signal S_{UHF1}. According to one example, the first UHF signal S_{UHF1} is transmitted at radio frequencies between 25 MHz and 5 GHZ and more particularly in the range from 225 MHz to 3400 MHZ. According to various examples, the frequency range operated comprises a WI-FI range or even an RFID (Radio Frequency Identification) range. More generally, any available frequency range having power is likely to be operated.

According to one embodiment with reference to FIG. 1, the UHF transmitter is configured to transmit the first UHF signal S_{UHF1} toward a first radio tag ET₁. The first radio tag ET₁ then comprises reception means for receiving said energizing signal S_{UHF1}. One advantage is to provide radioelectric energy to the radio tag to enable it to transmit a signal, in particular a UWB signal when the tag comprises UWB transmission means.

According to one embodiment, the UHF transmitter EM_{UHF} comprises a plurality of transmission antennas. For example, each transmission antenna is oriented in a different direction than the other transmission antennas. According to one alternative, the transmission antennas are oriented in the same direction. Each transmission antenna is configured to transmit at least one part of the energizing UHF signal S_{UHF1}.

One advantage is to be able to provide UHF energy to multiple radio tags, each located in different positions. Another advantage is to increase the UHF coverage of the mobile beacon when controlling the UHF beam directionality is made difficult by the hardware configuration, for example when the mobile beacon is made integral with an element likely to move such as a mobile cart.

In one embodiment, the plurality of transmission antennas comprises a phased-array antenna. The phases of the signals supplying each of the antennas can be adjusted, for example to obtain a specific radiation diagram.

In one embodiment, the power of the UHF signal delivered by each of the antennas is modulable. By “Modulable”, it is meant that the intensity or power of the UHF signal delivered by one of the antennas can be controlled, for example by control means. The control means can be controlled by a user. Controlling by a user is for example implemented by means of a user interface of an electronic device comprising the mobile beacon B_{M} or paired with said mobile beacon B_{M}. In one embodiment, the control means are configured to control at least one transmission antenna. By “control”, it is meant both “modulating the UHF signal delivered by a transmission antenna” and shutting down a transmission antenna. By “shutting down”, it is meant that a transmission antenna no longer delivers the first energizing UHF signal S_{UHF1}. This configuration is particularly advantageous for concentrating the first UHF signal S_{UHF1} at the output of a single transmission antenna when a UWB tag is facing said transmission antenna. The position of the mobile beacon B_{M} can then advantageously be associated with the position of the tag originating the transmission of said UWB signal.

In one embodiment, each antenna of the plurality of transmission antennas is configured to deliver part of the first energizing UHF signal S_{UHF1}. This is particularly advantageous to allow a wider UHF coverage in the transmission zone, especially when a UWB tag to be energized has not yet been located.

### UWB Receiver of the Mobile Beacon

According to one embodiment, the mobile beacon B_{M} comprises a UWB (Ultra-Wide Band) receiver REC_{UWB}. The UWB receiver REC_{UWB} is capable of receiving at least one UWB signal. The UWB signal received may for example be a first signal UWB signal S_{UWB1} from the first UWB tag ET₁ energized by the first UHF signal S_{UHF1}.

One advantage is to be able to associate position of the first UWB tag ET₁ originating the transmission of the UWB signal S_{UWB1} with a position of the mobile beacon B_{M}. Another advantage is to be able to determine movement of the mobile beacon B_{M} according to the transmission frequency of the first UWB tag ET₁. For example, the increase in the transmission frequency of the first UWB tag ET₁ can be associated with the mobile beacon BM moving closer to said first UWB tag ET₁ and the decrease in the transmission frequency of the first UWB tag ET₁ can be associated with the mobile beacon B_{M} moving away from said first UWB tag ET₁.

In one embodiment, the UWB receiver REC_{UWB} of the mobile beacon B_{M} comprises at least one receiving antenna UWB. Each receiving antenna UWB may be oriented at a predetermined angle relative to the direction along which any of the other receiving antennas UWB extends. One advantage is to improve reception of the UWB signals by the UWB receiver REC_{UWB} of the mobile beacon, in particular by increasing the reception spatial coverage of the receiving antennas UWB. Another advantage is to be able to determine more precisely position of a UWB tag according to the angle of arrival of the UWB signal transmitted by said UWB tag and received by at least one receiving antenna of the UWB receiver of the mobile beacon.

In one embodiment, the UWB receiver REC_{UWB} of the mobile beacon B_{M} comprises a phased-array antenna. This embodiment is particularly advantageous for obtaining spatial selectivity on radio signals by “beamforming” or “spatial filtering”. These expressions are better known in Anglo-Saxon literature as beamforming.

According to one embodiment, the mobile beacon B_{M} comprises a calculator. The calculator is configured to calculate, for each receiving antenna of the UWB receiver REC_{UWB} of the mobile beacon B_{M}, power of the first UWB signal S_{UWB1} received. One advantage is to be able to correlate power received by each antenna with the angle of arrival of the first UWB signal S_{UWB1} received to improve locating the UWB tag originating the transmission of said first UWB signal S_{UWB1}.

In one embodiment, transmitting the first signal UHF₁ by the UHF transmitter EM_{UHF} of the mobile beacon causes the reception of the first UWB signal S_{UWB1} by the UWB receiver RE_{UWB} of the mobile beacon B_{M}. According to one illustrative example, the first UHF signal S_{UHF1} transmitted is then received by the first UWB tag ET₁ which then automatically, and preferably spontaneously, transmits the first UWB signal S_{UWB1} in response to the energy input provided by receiving the first UHF signal S_{UHF1}. The spontaneous transmission of a UWB signal by the UWB tag ET₁ is triggered as soon as a sufficient level of radio frequency energy is collected. The first UWB signal S_{UWB1} transmitted by the first UWB tag ET₁ is then received by the UWB receiver REC_{UWB} of the mobile beacon B_{M}.

### First Tag Piece of Data D1

According to one embodiment, the first UWB signal S_{UWB1} comprises a first tag piece of data D₁. The first tag piece of data D₁ further comprises information specific to the first tag ET₁ originating the transmission of the first UWB signal S_{UWB1}. The information included in the first piece of data D₁ includes, for example, position of the first tag ET₁ or even information on an object to which said first tag ET₁ is affixed, for example a parcel or luggage.

The first tag piece of data D₁ received by the mobile beacon B_{M} is recorded in a memory MEM of the mobile beacon B_{M}. The reception of the first UWB signal S_{UWB1} comprising the first tag piece of data D₁ is timestamped to produce a first timestamping piece of data H₁ associated with said first piece of data D₁.

### Identification of the Mobile Beacon Position

With reference to FIG. 2, the invention aims to associate position of the mobile beacon B_{M} with a first piece of data D₁ transmitted by a radio tag. The association can be carried out deferred or in real time depending on the system implemented. Thus, it is possible to deduce position of the first radio tag ET₁ from the calculated position of the mobile beacon that “saw” the tag that is ultimately being sought to be located.

To achieve this result, the invention allows the position of the mobile beacon B_{M} to be measured or calculated. Different locating techniques can be implemented. These different locating techniques may involve the mobile beacon playing a more or less active role in the production of data for locating it. According to some cases, the beacon does not know its position but transmits data enabling it to be located by a third-party system. In some cases, the mobile beacon B_{M} calculates or receives its position so as to associate it directly with the first piece of data D₁ transmitted by the tag ET₁.

In the remainder of the description, different locating systems are described according to different embodiments of the invention.

### Associating Position of the Mobile Beacon and of the Radio Tag

In one embodiment, the first position piece of data POS₁ is associated with the position of at least one UWB tag energized by the first UHF energizing signal S_{UHF1}. The association can be performed within the memory MEM of the mobile beacon B_{M}. In this case, the data associated can be transmitted in real time or delayed by the beacon to a third-party system. Association can also be carried out within a piece of equipment of a data network NET. This a posteriori association involves data transmission and processing for reconstructing the association context between the mobile beacon B_{M} and the first UWB tag ET₁. For example, timestamping, position, or other data used to a posteriori calculate the position of the UWB tag ET₁.

### Location System

The position of the mobile beacon B_{M} is determined by means of a location system L_{GEO}.

According to one embodiment, the location system L_{GEO} comprises means for transmitting a first position piece of data POS1 of the mobile beacon B_{M} which can be operated by a system. Operating may comprise reconstructing a position, associating a first position piece of data POS₁ of the mobile beacon B_{M} with a tag piece of data or retransmitting said first position piece of data POS₁ to the mobile beacon B_{M} or to a server for a posteriori operating this piece of data.

Different locating techniques can be implemented. For example, the location system L_{GEO} may comprise a reference tag ET_{ref} having known position or a satellite positioning system, also called GNSS (Global Navigation Satellite System). According to various non-limiting examples, the GNSS system comprises a GPS, GLONASS, BEIDU or Galileo system.

In one embodiment, the GNSS system is coupled to a positioning improvement system. According to various examples cited by way of non-limiting purposes, the positioning improvement system comprises a system of the SBAS type, or even a GBAS system. In some cases, such a system operates connectivity of the mobile beacon B_{M} (4G, Wi-Fi, LoRa, etc.)

Other location techniques may be implemented. For example, the location system L_{GEO} may comprise a geocoder geolocation system, a Wi-Fi geolocation system, a geolocation system by the use of a telecommunication operator, an odometry location system, or even a Radio Frequency Identification (RFID) geolocation system. According to different examples, the location system by using a telecommunications operator comprises, for example, the use of a LoRa technology or even a GSM (“Global System for Mobile communications”) technology.

In one embodiment, the location system L_{GEO} comprises a “quick response code”, or even “QR code”. For example, this quick response code is positioned in the detection environment to a position known to the system. According to different non-limiting examples, the code is positioned on a wall, floor, ceiling, crate, or any other fixed position element in the detection enviornment.

In one case, the location system L_{GEO} comprising said quick response code is scanned by a device configured to decode information contained in said code. Such a device is for example embedded by a user or embedded by the mobile beacon B_{M}. In this case, the scanned information is then transmitted to the equipment of the data network NET by means of the communication interface INTc.

Advantageously, a link can then be established between the decoded and transmitted information and the geographical position of the code known by the system to deduce position of the user or of the mobile beacon B_{M} which scans said code.

In one embodiment, the quick response code contains location data. These data include, for example, terrestrial coordinates corresponding to the position of said code in the location environment. In this case, a user or a mobile beacon B_{M} embedding a scanner to decode said code can transmit the scanned data to a piece of equipment on the data network NET, for example by means of the communication interface INTC. Advantageously, it is not necessary to make the link between the transmitted data and a position known to the system in that the transmitted information already includes the position data of said code.

According to different embodiments, the quick response code is scanned by means of different sensors such as sensors comprising laser technologies, optical sensors for example by means of a camera. These examples are not limiting and any type of technologies comprising means for decoding data stored in a quick response code are likely to be implemented in the scope of the invention.

In one example, a video acquisition system comprising a camera is implemented to acquire an image or a video sequence of a zone of the detection environment comprising a location system L_{GEO} comprising a quick response code. The video acquisition system is for example embedded by the mobile beacon B_{M}, by a mobile cart embedding the mobile beacon B_{M} or by a user.

Thus, the “view angle” of the image or video sequence acquired on which one or more quick response codes appear advantageously makes it possible to determine or confirm a position of the mobile beacon B_{M} or the user, or to determine an orientation piece of information.

According to another embodiment, the mobile beacon B_{M} comprises a camera configured to detect particular wavelengths, for example an infrared camera. For example, the camera is embedded on a mobile beacon B_{M} itself embedded by a user. For example, the camera is positioned on the top of the mobile beacon B_{M}. In one case, the camera senses specific wavelengths from sources positioned in specific zones. The mobile beacon B_{M} equipped with the camera can then recognize particular patterns or particular wavelengths to determine its position. In another example, an image or video sequence acquired by the camera is operated and analyzed using a calculator to determine a position, orientation, or path of the mobile beacon B_{M} as a function of time.

However, the elements included in the location system L_{GEO} are not limited to the above-mentioned examples and may comprise any type of elements capable of contributing to the location of an object in space; or even a combination of these different elements, for example to improve accuracy of the location or cover a larger zone than with a single location technique.

### Location by a UWB System (Fixed Beacons)

In one embodiment, the position of the mobile beacon B_{M} is calculated by trilateration by a plurality of beacons. These beacons are also called “fixed beacons” to differentiate them from the mobile beacon B_{M}.

Each beacon includes UWB reception means configured to receive at least one second UWB signal S_{UWB2} transmitted by the mobile beacon B_{M}. For example, the second UWB signal S_{UWB2} comprises at least one identification piece of data of the mobile beacon B_{M} encoded in said second UWB signal S_{UWB2}. This configuration is particularly advantageous for locating the mobile beacon B_{M} in an indoor environment, particularly when a detection architecture comprising a plurality of beacons is set up and localization by another system such as a GNSS system is not suitable.

In one embodiment, the mobile beacon B_{M} is configured to transmit the second UWB signals S_{UWB2} several times. The successive transmissions allow ensuring reception of said second UWB signal S_{UWB2} by the fixed beacons in order to increase probability of detection of the mobile beacon. According to one case, the transmissions of the mobile beacon are performed according to a periodic frequency. This case may be implemented in particular when the mobile beacon includes a battery enabling it to make use of sufficient electric energy to generate successive transmissions. Advantageously, the detections of the second signals S_{UWB2} successively by a plurality of beacons present in the detection environment are improved, thus improving the location accuracy of the mobile beacon B_{M} in the detection environment.

In another embodiment, time filtering is implemented on the second UWB signals S_{UWB2} transmitted successively by the mobile beacon B_{M}. One advantage is to oversample the calculated position from said second UWB signals S_{UWB2}, for example to eliminate a location noise.

According to one exemplary embodiment, the plurality of beacons is configured to calculate position of the mobile beacon B_{M} by trilateration to produce the first position piece of data POS₁. The first position piece of data POS₁ can then be operated in different ways so that it is associated with the first tag piece of data D₁. The association can be made:
at a fixed beacon when the first tag piece of data D₁ is retrieved by the latter.
at a third-party piece of equipment such as a server when the latter receives by the UWB location system the first position piece of data POS₁ and receives by another data transmission system the first tag piece of data D₁.
at the mobile beacon B_{M} when the position of beacon B_{M} calculated by trilateration is retransmitted to the mobile beacon B_{M}.

In a first case, the association between the first tag piece of data D₁ and the first position piece of data POS₁ is carried out at a fixed beacon. In this first case, the second UWB signal S_{UWB2} is transmitted by the mobile beacon B_{M} and includes the first tag piece of data D₁ and the first timestamping piece of data H₁. The second UWB signal S_{UWB2} is then received by a fixed beacon or a plurality of fixed beacons. The position of the mobile beacon B_{M} is calculated by trilateration by the plurality of fixed beacons to produce the first position piece of data POS₁. The first position piece of data POS₁ is then associated with the first tag piece of data D₁ within a memory of one of the fixed beacons.

In a second case, the association between the first tag piece of data D₁ and the first position piece of data POS₁ is performed at a third-party piece of equipment such as a piece of equipment of a data network NET. In this case, the first position piece of data POS₁ is calculated by trilateration by a plurality of beacons and the first position piece of data POS₁ is then transmitted by the plurality of beacons to the piece of equipment of the data network NET. The first piece of information Sₜᵣₐₙₛ₁ comprising the first tag piece of data D₁ as well as the first timestamping piece of data H₁ is transmitted by the mobile beacon B_{M} to the piece of equipment of the data network NET. Thus, the association between the first position piece of data POS₁ calculated by trilateration by the plurality of fixed beacons and the first tag piece of data D₁ transmitted by the mobile beacon B_{M} can be a posteriori carried out retrospectively at the piece of equipment of the data network NET.

In a third case, the association between the first position piece of data POS₁ and the first tag piece of data D₁ is performed within the mobile beacon B_{M}. In this case, the first position piece of data POS₁ can come from different sources. The first position piece of data POS₁ can come from a reference tag having known position ET_{ref} and transmitted within a UWB signal to the mobile beacon B_{M} after said reference tag ET_{ref} has been energized by the UHF transmitter EM_{UHF} of the mobile beacon B_{M}. According to different embodiments, the reference tag ET_{ref} is supplied by an electric energy storage device such as a battery, by an AC/DC power supply or even by an external DC power supply such as, for example, a “Power Over Ethernet” (POE). However, the above examples are given by way of indicating and in no way limiting purposes. More generally, any type of power supply is likely to be implemented to supply the reference tag ET_{ref}. According to other examples, the first position piece of data POS₁ comes from a GNSS location system or even from a plurality of fixed beacons having calculated position of the mobile beacon by trilateration. Generally speaking, in this third case, the first position piece of data POS₁ may come from any of the location systems L_{GEO} described previously. The association between the first tag piece of data D₁ and the first position piece of data POS₁ is then performed in the memory MEM of the mobile beacon B_{M}. The mobile beacon B_{M} can then advantageously transmit the first piece of information Sₜᵣₐₙₛ₁ comprising the first tag piece of data D₁ associated with said first position piece of data POS₁ to a piece of equipment of a data network NET.

### Location by a Sensor Located on the Mobile Beacon

In one embodiment, the first position piece of data POS₁ is determined from one or more sensors embedded by the mobile beacon B_{M}. The sensors embedded by the mobile beacon B_{M} may include, for example, an inertia unit or a laser rangefinder. However, sensors used to determine the position of the mobile beacon B_{M} are not limited to the aforementioned examples and may comprise any other type of sensor or a combination of several sensors together. One advantage is to obtain a piece of information on the position of the mobile beacon B_{M} when the use of other location systems is not optimized, for example when the beacon is in an indoor environment and the use of a GNSS system is unsuitable. Another advantage is to be able to combine the information from the sensors with other information from other location systems to improve accuracy of locating the mobile beacon B_{M}.

In one embodiment, the first position piece of data POS₁ comprises a piece of information from at least one sensor embedded by the mobile beacon B_{M} and a piece of information from a signal received by the mobile beacon B_{M}. For example, the signal received may comprise the first UWB signal S_{UWB1} from the first UWB tag ET₁ located in proximity to the mobile beacon B_{M}. According to one example, an association of the piece of information from the at least one sensor embedded by the mobile beacon B_{M} and the signal received by said mobile beacon is performed within the memory MEM of the mobile beacon B_{M}. Advantageously, accuracy of the calculation of the position of the mobile beacon B_{M} is improved. Another advantage is to be subsequently able to use the mobile beacon B_{M} whose position is precisely known within a constellation of beacons to implement position calculations by trilateration.

### Detection of the UWB Signal Transmitted by the Mobile Beacon

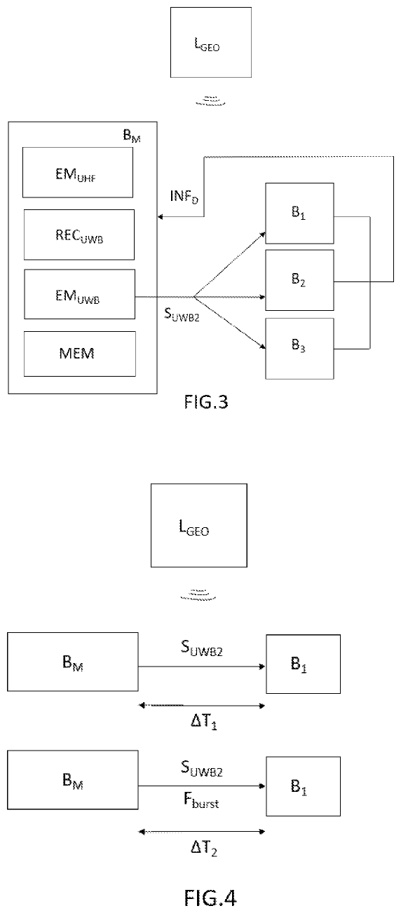

In one embodiment, with reference to FIG. 3, the second UWB signal S_{UWB2} transmitted by the mobile beacon B_{M} is received by the location system L_{GEO} comprising the plurality of beacons. The plurality of beacons comprises radio reception means, means for decoding a piece of information and means for timestamping arrival of the UWB signal S_{UWB2}. The plurality of beacons is configured to transmit a detection piece of information INF_{D} of the second UWB signal S_{UWB2} to a third-party piece of equipment or to the mobile beacon B_{M}. The detection piece of information may be an acknowledgement transmitted to the mobile beacon and/or may be a piece of information relating to the quality of reception of the signal received by a fixed beacon and retransmitted to the mobile beacon B_{M} or to a third-party piece of equipment.

When the detection piece of information INF_{D} is transmitted to the beacon, it may further comprise a piece of information, by the plurality of beacons, of receiving the UWB signal S_{UWB2} previously transmitted by the mobile beacon B_{M}. One advantage is to know whether the signal transmitted by the mobile beacon B_{M} is actually detected by the plurality of beacons.

In one embodiment, with reference to FIG. 4, the mobile beacon B_{M} is configured to transmit a plurality of second UWB signals at an increased frequency F_{burst} in case of non-reception of the detection piece of information INF_{D}. Transmission of the plurality of UWB signals can occur in case of non-reception of the detection piece of information INF_{D} after a first time interval ΔT₁. The transmission of the plurality of second UWB signals can take place during a second time interval ΔT₂. The two time intervals ΔT₁ and ΔT₂ may have been parameterized upstream by a user, for example, using a configuration console for configuring transmission variables of the beacon. Transmission of the plurality of UWB signals at the increased frequency F_{burst} can also come from a command sent by a piece of equipment of a data network NET. One advantage is to ensure detection of the mobile beacon B_{M} by a beacon or a constellation of beacons when the first second UWB signal S_{UWB2} has not been detected first.

In one alternative, transmission of the plurality of second UWB signals ends when the mobile beacon B_{M} receives the detection piece of information INF_{D}.

### Synchronization of Clocks of the Beacons and Position Calculation

The invention makes it possible to take account of a synchronization signal generated by reference equipment, the relative position towards reception beacons or fixed beacons of which is known. This last signal makes it possible to synchronize the different beacons with each other in order to minimize errors and to precisely calculate the position of a mobile beacon B_{M} and therefore the radio tag whose position is sought to be obtained via the mobile beacon B_{M}.

Different synchronization techniques may be used within the scope of the invention. According to one example, this signal can be transmitted from a reference radio tag ET_{ref} whose position is known to the system.

According to one embodiment, with reference to FIG. 5, the method according to the invention comprises transmitting, by a reference tag ET_{ref}, a third UWB signal S_{UWB3} comprising a first time piece of information T₁ and a second tag piece of data D₂. Transmitting the third UWB signal S_{UWB3} is conditioned by the power supply of said reference tag ET_{ref} by an energy source. According to various examples, the energy supply source implemented to supply the reference tag ET_{ref} comprises a UHF source or an electric energy supply source such as a battery or even an external source. The external source is, for example, AC/DC power supply, power supply via Ethernet cable or power supply via solar panels. In one alternative, the energy supply source of the reference tag ET_{ref} comprises a combination of several of these technologies. In one example, the UHF energy source is the UHF transmitter EM_{UHF} of the mobile beacon B_{M}. The time piece of information T₁ comprises, for example, timestamping of the transmission of the third UWB signal S_{UWB3}. The second tag piece of data D₂ comprises, for example, a piece of information on the position of the reference tag ET_{ref} or even an identification piece of information of said reference tag ET_{ref}.

According to one embodiment, the third UWB signal S_{UWB3} is received by the mobile beacon B_{M} by means of the UWB receiver REC_{UWB}. Receiving said third signal S_{UWB3} is then timestamped to produce a second timestamping piece of data H₂ associated with receiving, by the mobile beacon B_{M} of the second tag piece of data D₂ and the first timestamping piece of data D₁. In this case, the mobile beacon B_{M} can then transmit a third piece of information Sₜᵣₐₙₛ₃ comprising the first time piece of information T₁, the second tag piece of data D₂ and the second timestamping piece of data H₂ to at least one piece of equipment of a data network NET. One advantage is to be able to deduce, from the first time piece of information T₁ and the second timestamping piece of data H₂, the travel time of the signal transmitted by the reference tag ET_{ref} to the mobile beacon B_{M}.

The synchronization signals can be directly operated by the beacons or a posteriori operated by a third-party piece of equipment in order to reconstruct positions of the mobile beacon B_{M} and/or the radio tag ET₁. In one embodiment, the mobile beacon B_{M} and a plurality of UWB radio beacons are configured to each transmit a third piece of information Sₜᵣₐₙₛ₃. Each third piece of information Sₜᵣₐₙₛ₃ comprises the first time piece of information T₁ comprising timestamping of the transmission of the third UWB signal S_{UWB3} from the reference tag ET_{ref}. Each third piece of information Sₜᵣₐₙₛ₃ also includes the second piece of data D₂ and a timestamping piece of data, said timestamping piece of data comprising timestamping, for each of the beacons, of the reception of the third signal UWB S_{UWB3} from the reference tag ET_{ref}. For example, each third piece of information Sₜᵣₐₙₛ₃ is transmitted to a piece of equipment of a data network NET. A propagation time piece of information of the third UWB signal S_{UWB3} is then determined for each of the beacons. The propagation time piece of information can be determined from the timestamping piece of data produced after reception of the third UWB signal S_{UWB3} by one of the beacons and from the first time piece of information T₁, for example by subtracting the time of transmission of the third UWB signal S_{UWB3} from the time of reception of said third UWB signal S_{UWB3}. In this example, the propagation time piece of information then comprises the travel time of the third UWB signal S_{UWB3} from its transmission by the reference tag ET_{ref} until its reception by one of the beacons or by the mobile beacon B_{M}. This means that the entire location system can be coordinated and synchronized by sending a synchronization signal for each beacon.

In one embodiment, the mobile beacon B_{M} and/or one of the beacons comprises calculation means configured to determine the propagation time piece of information from the timestamping piece of data and the first time piece of information T₁, said propagation time piece of information comprising the travel time of the third UWB signal S_{UWB3} between the reference tag ET_{ref} and the beacon comprising said calculation means. This advantageously enables the calculation of the propagation time of the third UWB signal S_{UWB3} to be implemented directly within the beacons so as to be able to transmit the propagation time piece of information via the third piece of information Sₜᵣₐₙₛ₃ subsequently transmitted. In one alternative, calculating the propagation time piece of information is subsequently implemented, after receiving the third piece of information Sₜᵣₐₙₛ₃ by a piece of equipment of a data network NET.

In one embodiment, calculating the propagation time piece of information is implemented for each of the beacons. Calculating the propagation time piece of information can also be implemented for the mobile beacon B_{M}. Each propagation time piece of information includes the travel time of the third UWB signal S_{UWB3} between the reference tag ET_{ref} originating its transmission and each of the beacons. Each propagation time piece of information can then be compared, for example by means of a comparator, to determine the different travel times of the third UWB signal S_{UWB3} between the reference tag Et_{ref} originating its transmission and each of the beacons. Advantageously, this allows the clocks of the different beacons to be synchronized with each other to enable the use of the beacons in the implementation of subsequent calculations, for example, calculations of the position of an object by trilateration.

Trilateration with the Mobile Beacon

In one embodiment, calculating the position of at least one radio tag UWB ET₁ is implemented by trilateration, said trilateration being implemented by means of the mobile beacon B_{M} and by means of at least two beacons. In this embodiment, the position of the mobile beacon B_{M} has previously been precisely determined, for example by means of the location system S_{GEO}.

One advantage is to be able to use a mobile beacon in implementing position calculations by trilateration, when the precise position of the mobile beacon B_{M} has been determined, for example by means of the location system S_{GEO}. Another advantage is to improve location precision of a pre-existing fixed detection infrastructure by adding a beacon with a specific position to the location infrastructure.

In one embodiment, at least one mobile beacon B_{M} having known position is implemented in a method for calculating a position of at least one second mobile beacon B_{M}. Determining the position of the second mobile beacon B_{M} advantageously enables said second mobile beacon B_{M} to be used in the subsequent implementation of calculations of the position of an object by trilateration. Another advantage is to be able to track the movement of one or a plurality of mobile beacons over time by implementing position calculations at regular time intervals.

### Data Exchange Between the Mobile Beacon and the Data Network

According to one embodiment, the mobile beacon B_{M} comprises means for transmitting a first piece of information Sₜᵣₐₙₛ₁. The first piece of information Sₜᵣₐₙₛ₁ comprises the first tag piece of data D₁ and the first timestamping piece of data H₁ associated with said first tag piece of data D₁. The first piece of information Sₜᵣₐₙₛ₁ is transmitted to a data server by non-wireless communication means. In one example, the non-wireless communication means include a Wi-Fi, 4G, 5G or even Bluetooth link. One advantage is to be able to store on a data server information related to an object or parcel to which the tag ET₁ originating transmission of the first tag piece of data D₁ is affixed.

In one embodiment, the first piece of information Sₜᵣₐₙₛ₁ is sent continuously to a piece of equipment of a data network NET. This is made possible in particular when the mobile beacon B_{M} is permanently connected to the data network NET via the non-wired connection means.

In one embodiment, the mobile beacon B_{M} is configured to receive data from a piece of equipment of the data network NET. This scenario is advantageous when a user wishes to determine position of a radio tag ET₁ and wishes to access the information system managing all the positions of the tags from their mobile beacon. Thus, the mobile beacon B_{M} can act as an access terminal to the data of the radio tags, for example by means of a user interface connected to said mobile beacon B_{M}. This is made possible when the mobile beacon B_{M} is connected to a piece of equipment of the data network NET by the non-wired connection means.

According to one embodiment, the mobile beacon B_{M} can store data received from the piece of equipment of the data network NET within its memory MEM. The data received may, for example, include recent data stored on the piece of equipment of the data network NET by another mobile or fixed beacon. One advantage is to establish a bidirectional link between the mobile beacon B_{M} and the piece of equipment of the data network NET in order to be able to receive updated information on several elements of the system, for example position of other mobile beacons or information on UWB tags that have recently been energized.

### UHF Mapping by the Mobile Beacon

In one embodiment, the method according to the invention comprises receiving a first amount of UHF energy B_{UHF1} by the mobile beacon B_{M}. Receiving the first amount of UHF energy E_{UHF1} is performed by means of a UHF receiver REC_{UHF} of the mobile beacon B_{M}. The first amount of UHF energy E_{UHF1} is then compared with a threshold energy value E_{threshold}. The threshold energy value E_{threshold} is, for example, the energy value from which it is assumed that a zone of the environment is sufficiently supplied with UHF energy and does not require additional UHF energy supply to allow sufficient detection of the UWB radio tags present in this zone of the environment. In one example, the threshold energy value is a predetermined threshold energy value. The predetermined threshold energy value is, for example, configured by a user using the user interface connected to an electronic device comprising the mobile beacon B_{M} or paired with said mobile beacon B_{M}. The comparison between the first amount of UHF energy E_{UHF1} and the threshold energy value E_{threshold} is, for example, carried out by means of a comparator and makes it possible to determine whether the first amount of UHF energy E_{UHF1} is lower or higher than the threshold energy value E_{threshold}. Comparing the first amount of UHF energy E_{UHF1} with the threshold energy value E_{threshold} makes it possible in particular to determine whether a zone is sufficiently supplied with UHF energy by the infrastructure or whether, on the contrary, this zone requires an additional UHF power supply to allow the tags present in said zone to transmit UWB frames.

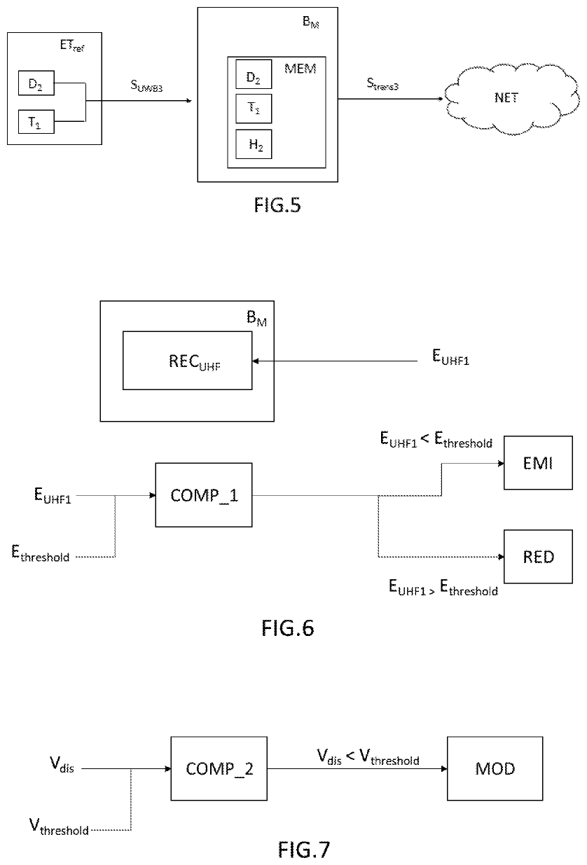

In one embodiment, with reference to FIG. 6, the mobile beacon B_{M} is configured to transmit the first UHF signal S_{UHF1} if the first amount of UHF energy E_{UHF1} is less than the threshold energy value E_{threshold} and to reduce energy transmitted by the UHF transmitter EM_{UHF} in the event that the first amount of UHF energy E_{UHF1} received is greater than the threshold energy value E_{threshold}. This configuration advantageously makes it possible to “map” the UHF energy of several zones and, a posteriori, either to supply UHF energy to a weakly supplied zone, or on the contrary, to reduce transmission of UHF signals by the mobile beacon B_{M} if the zone is already sufficiently supplied. In one example, transmission of the first UHF signal S_{UHF1} advantageously results in the spontaneous transmission of UWB signals by tags present in an initially low-energized zone. Another advantage is to be able to detect change of state in the detection environment, for example a failure of a transmitter or a re-arrangement of elements in the environment resulting in an increase or decrease in the overall detected UHF energy. Another advantage is to be able to reduce overall power consumption of the system by reducing the UHF power transmitted by the different beacons in the zone if said zone is already sufficiently energized.

In one embodiment, the mobile beacon B_{M} is configured to transmit a signal comprising a UHF coverage piece of information. The UHF coverage piece of information may comprise, for example, a piece of information on the amount of UHF energy received by the mobile beacon B_{M}. The signal comprising the UHF coverage piece of information may be, for example, the second UWB signal S_{UWB2} if the UHF coverage piece of information is sent to equipment comprising a UWB receiver, such as a fixed beacon or another mobile beacon. The signal comprising the UHF coverage piece of information may also be of a different nature, if the UHF coverage piece of information is sent to another piece of equipment, such as a piece of equipment in a data network NET. One advantage is to be able to collect information on the amount of UHF energy present in a zone of the environment, in order to be able to a posteriori modulate the UHF energy transmitted by the different beacons near the zone in which the mobile beacon B_{M} performs a UHF coverage diagnosis, according to the amount of UHF energy present in said zone.

### Near Field Illumination

In one embodiment, with reference to FIG. 7, the method according to the invention comprises measuring a distance value V_{dis} between an object and the mobile beacon B_{M} by means of a distance sensor. The distance sensor may comprise, for example, an ultrasonic sensor, an inductive sensor, a magnetic sensor, an optical sensor or even a capacitive sensor. The distance sensor can be an infrared range finder, for example. However, the distance sensor used is not limited to the aforementioned examples and may comprise any type of sensor for evaluating a distance between said sensor and an object, or even a combination of different sensors for obtaining a more accurate value of the distance between the object and the mobile beacon B_{M}.

In one embodiment, the distance value V_{dis} measured by means of the sensor is compared with a predetermined threshold distance value V_{threshold}. Comparison can be done using a comparator COMP.

In one example, transmission of the first energizing UHF signal S_{UHF1} is then modulated according to the result of the comparison between the distance value V_{dis} and the predetermined threshold distance value V_{threshold}. Modulating the first UHF signal S_{UHF1} may, for example, comprise increasing power of said first UHF signal S_{UHF1} delivered when the distance value V_{dis} is greater than the predetermined threshold distance value V_{threshold}. This advantageously makes it possible to adapt the signal when the UHF transmitter EM_{UHF} of the mobile beacon B_{M} is at a position away from a UWB tag, to ensure detection of said UHF signal S_{UHF1}. Modulating the first UHF signal S_{UHF1} may also comprise reducing power of said first UHF signal S_{UHF1} when the distance value V_{dis} is less than the predetermined threshold distance value. This advantageously makes it possible to reduce the overall energy consumption of the system by reducing power of the first UHF signal S_{UHF1} transmitted when the UHF transmitter EM_{UHF} of the mobile beacon B_{M} is close to a UWB radio tag to be energized.

In one alternative, modulating the first UHF signal S_{UHF1} comprises increasing power of said first UHF signal S_{UHF1} when the distance value V_{dis} from the UHF transmitter to the object is less than the distance value threshold V_{threshold}. This advantageously makes it possible to optimize UHF energy supply of a UWB radio tag when the UHF transmitter of the mobile beacon B_{M} is close to said UWB radio tag to be energized. Another advantage is to confirm presence of a UWB radio tag on the object in proximity to the mobile beacon. Indeed, a UWB radio tag is configured to transmit at least one UWB signal in response to the power supply provided by a UHF signal.

In one alternative, modulating the first UHF signal S_{UHF1} comprises reducing power of said first UHF signal S_{UHF1} when the distance value V_{dis} from the UHF transmitter to the object is greater than the distance value threshold V_{threshold}. This advantageously allows the energy of the UHF power source to be saved when the UWB radio tags are too distant to be properly energized.

In one embodiment, receiving a UWB signal by the UWB receiver REC_{UWB} of the mobile beacon B_{M} causes power of the first UHF signal S_{UHF1} to increase in response to said receiving the UWB signal. This increase in power can, for example, be implemented by a user via a user interface. In this case, the user interface comprises a control unit for modulating the UHF signal transmitted by the UHF transmitter EM_{UHF} of the mobile beacon and means for informing the user of the reception of a UWB signal by the mobile beacon B_{M}, for example, visual or audible alert means. One advantage is to ensure that the UWB signal received by the mobile beacon B_{M} comes from a UWB radio tag located in proximity to the UHF source.

In one embodiment, the first UWB signal S_{UWB1} received by the mobile beacon B_{M} is associated with a duration time piece of information. The duration time piece of information comprises, for example, the duration during which the first UWB signal S_{UWB1} transmitted by the first UWB tag ET₁ has been received by the mobile beacon B_{M}. The duration time piece of information may also comprise the first timestamping piece of data H₁ of the reception of said first signal UWB S_{UWB1} by the mobile beacon B_{M}. The duration time piece of information can, for example, be stored in the memory MEM of the mobile beacon B_{M}. One advantage is to associate a reception duration with a UWB signal received by the mobile beacon B_{M}, for example to ensure that said received UWB signal actually comes from a UWB tag located in proximity to the mobile beacon.

According to one embodiment, the duration time piece of information associated with the first UWB signal S_{UWB1} is sent to a piece of equipment of a data network NET by means of a non-wired link. The non-wired link may comprise WI-FI, 4G, 5G, or Bluetooth transmission means. This configuration is particularly advantageous when a same UWB signal is received by a plurality of mobile beacons. The duration time piece of information comprising the duration of reception of the first UWB signal makes it possible to determine which mobile beacon B_{M} is located in proximity to the UWB radio tag originating transmission of said first UWB signal S_{UWB1}.

In one alternative, the duration time piece of information associated with the first UWB signal S_{UWB1} may be transmitted to a UWB receiver of a fixed beacon or another mobile beacon within the second UWB signal S_{UWB2} transmitted by the UWB transmitter EM_{UWB} of the mobile beacon B_{M}. According to one embodiment, the duration time piece of information is associated with the distance value V_{dis} from the UHF transmitter to the object. In this example, the first tag UWB ET₁ is affixed to the object from which the distance value V_{dis} is measured. The association can be made within the memory MEM of the mobile beacon or within a piece of equipment of a data network NET. This configuration is advantageous in the event that a same UWB signal is received by a plurality of mobile beacons. It is thereby possible to more precisely identify the mobile beacon B_{M} located in proximity to the radio tag UWB originating transmission of the first UWB signal S_{UWB1} sensed by a plurality of mobile beacons B_{M}. Another advantage is to reduce uncertainty on the position of the UWB radio tag originating transmission of the first UWB signal S_{UWB1}.

### Background Information

In one embodiment, the first UWB signal S_{UWB1} received by the mobile beacon B_{M} is associated with a context piece of information. The context piece of information also includes information on the context in which the mobile beacon B_{M} operates when it receives the UWB signals from an energized UWB tag. This context piece of information may notably comprise values associated with physical data related to the environment in which the mobile beacon B_{M} operates, or values associated with physical data related to the mobile beacon B_{M} itself. The context piece of information can, for example, comprise the distance value V_{dis} to an obstacle or even the distance value of the mobile beacon B_{M} to the ground, the first position piece of data POS₁, a movement piece of information of the mobile beacon B_{M} or even the duration time piece of information. The duration time piece of information comprises, for example, the duration during which the first UWB signal S_{UWB1} transmitted by the first UWB tag ET₁ has been received by the mobile beacon B_{M}. The duration time piece of information may also comprise the first timestamping piece of data H₁ of the reception of said first signal UWB S_{UWB1} by the mobile beacon B_{M}. In another case, the duration time piece of information comprises the time during which the environment has been energized by the embedded UHF transmitter EM_{UHF} by the mobile beacon B_{M}. According to another example, the context piece of information comprises a sound recording acquired by a sensor, or even an image or video sequence acquired by a camera positioned on the mobile beacon B_{M}.

In one embodiment, the context piece of information comprises information on the directionality of the UHF signal S_{UHF1} transmitted by the UHF transmitter EM_{UHF} of the mobile beacon B_{M}. According to one example, the piece of information comprises a privileged UHF direction piece of information for the UHF signal S_{UHF1}.

In one embodiment, the context piece of information comprises information on the duration between switching on and switching off transmission of the first energizing signal S_{UHF1}. According to one case, the context piece of information also includes information on antennas of the mobile beacon B_{M} involved in the transmission of the energizing signal S_{UHF1} and information on the orientation of said antennas in space.

In one embodiment, the duration piece of information comprises a piece of information on the duration of energization of a UWB tag by the first energizing signal S_{UHF1} coupled to a piece of information on the power transmitted by the source S_{UHF1}.

According to one example, the context piece of information comprises a piece of information on the presence of other mobile beacon BMS in the detection environment. According to another example, the context piece of information comprises values measured by different sensors installed on the mobile beacon B_{M} such as position sensors, motion sensors, temperature sensors or even pressure sensors. The context piece of information may be processed by processing means to determine an identification piece of data of at least one mobile beacon having transmitted a first UHF energizing signal S_{UHF1} originating the transmission of a first UWB signal S_{UWB1} by a first UWB radio tag ET₁ and received by the mobile beacon B_{M}. One advantage is to be able to precisely identify a mobile beacon originating the transmission of an energizing UHF signal having energized a UWB radio tag, according to different physical parameters.

### Mobile Beacon

According to another aspect, the invention relates to a mobile beacon B_{M} configured to implement the method of the invention according to any one of the previously described embodiments.

In one embodiment, the mobile beacon B_{M} comprises means for storing an amount of electric energy. The means of storing an amount of electric energy in particular enable the UHF transmitter EM_{UHF} of the mobile beacon, or the various sensors installed on the mobile beacon B_{M} to be supplied with electric energy. The means of storing an amount of electric energy may, for example, comprise a battery. The battery can, for example, be charged at the mains. The means of storing electric energy may comprise any battery technology among lithium-ion, Ni-Cad, Ni-Mh or Pb/Sla technologies. However, this embodiment of the invention is not limited to the aforementioned battery technologies. In one embodiment, the mobile beacon may comprise an association of a plurality of battery technologies or even several batteries of similar technologies.

In one embodiment, the mobile beacon B_{M} comprises a photovoltaic source of electric energy supply. The photovoltaic source of electric energy supply comprises, for example, a solar panel or a plurality of solar panels.

The mobile beacon B_{M} may comprise an indicator of the charge level of the means for storing electric energy. The indicator may be a visual indicator such as a light indicator. According to one alternative, the indicator may be an audible indicator such as an alarm. The mobile beacon B_{M} may also comprise a combination of visual and/or audible indicators. The indicator can be configured to activate when the charge level of the electric energy storage means falls below a predetermined charge threshold. This configuration is particularly advantageous in the event that the electric energy storage means require a mains supply, to warn a user of the need to recharge said electric energy storage means. Another advantage is to be able to warn a user of a risk of malfunction of the mobile beacon B_{M} in the event of excessive discharge of said electric energy storage means.

In one embodiment, the mobile beacon B_{M} comprises embedded sensors. Embedded sensors can include pressure sensors, distance sensors, shock sensors, vibration sensors or temperature sensors. In general, the mobile beacon B_{M} may comprise any type of sensor for obtaining information on physical parameters of the environment in which said mobile beacon B_{M} operates, or even any type of sensor for measuring values of physical parameters derived from the interaction between said mobile beacon B_{M} and its environment. In one example, the different sensors are supplied by a battery of the mobile beacon B_{M}.

According to one embodiment in which the mobile beacon B_{M} comprises a plurality of sensors, the data measured by the different sensors are stored within the memory MEM of the mobile beacon B_{M}. According to one exemplary embodiment, the measured data are timestamped and stored in the memory MEM of the mobile beacon B_{M} are then sent to a piece of equipment of a data network NET. This is particularly advantageous for collecting information about the environment in which the mobile beacon B_{M} operates and about possible interactions between said mobile beacon B_{M} and its enviornment.

In one embodiment, the mobile beacon B_{M} comprises control means. The control means are configured to control transmission of the first UHF signal S_{UHF1} transmitted by the UHF transmitter EM_{UHF} of the mobile beacon B_{M}. The control means can be controlled by a user. Control by a user is, for example, implemented by means of a user interface of an electronic device comprising the mobile beacon B_{M} or paired with said mobile beacon B_{M}. The control means can make it possible to modulate the first UHF signal S_{UHF1} delivered by at least one transmission antenna of the mobile beacon B_{M}. The control means may also allow shutdown of at least one transmission antenna of the mobile beacon B_{M}. The control means may be autonomous. By “autonomous”, it is meant that the control means can be configured upstream by a user to automatically control modulation of a UHF signal transmitted by a transmission antenna or to control shutdown of a transmission antenna. This automatic control of transmission antennas may depend on the reception and processing of a piece of information from a sensor such as a motion sensor, a position sensor or any other sensor embedded by the mobile beacon B_{M}.

According to one embodiment, the mobile beacon may comprise one or a plurality of detection indicators. Detection indicators may be visual and/or audible indicators. According to one example, the detection indicators allow a user to be informed of the detection of a UWB signal by the mobile beacon B_{M}. Detection indicators can be, for example, indicator lights or alarms. The indicators may also be integrated into a user interface including, for example, a screen and sound transmission means. In this case, the visual indicators may comprise a detection message appearing on the user interface screen and the audible indicators the issuance of an alert sound by the sound transmission means. One advantage is to warn a user of the presence of a UWB transmitter such as a radio tag in the zone where the mobile beacon B_{M} is located. According to another example, receiving a UHF signal by a UHF receiver of the mobile beacon B_{M} causes the visual and/or audible indicators to be activated. An advantage is to warn a user of the presence of another UHF source in the zone in which the mobile beacon B_{M} is located.

In one embodiment, the mobile beacon B_{M} is configured to exchange data with at least one other mobile beacon. Data can be exchanged by transmitting a second UWB signal S_{UWB2} by the mobile beacon B_{M} and receiving said second UWB signal S_{UWB2} by another mobile beacon. The second UWB₂ signal may comprise some or all of the data stored in the internal memory of the mobile beacon B_{M}. One advantage is to allow data exchange between multiple mobile beacons when network coverage does not allow connection to a piece of equipment on the data network NET, for example when there is no WI-FI, 3G, 4G or 5G coverage.

According to one embodiment, the mobile beacon B_{M} comprises a memory. The memory allows the mobile beacon B_{M} to store decoded information of received signals, such as identification data of a piece of equipment having transmitted a signal received by the mobile beacon B_{M}, for example the first piece of data D₁, position data, for example the first position piece of data POS₁, timestamping data (such as timestamping of transmission and reception of UWB signals), data measured by sensors embedded by the mobile beacon B_{M}, or even the context piece of information.

The information is, for example, stored in the memory of the mobile beacon B_{M} as long as it is not connected to a data network, and is, for example, transmitted to a remote equipment by means of a wireless link as soon as the connection is reestablished. This transmitted information can be subsequently operated on a remote equipment or on a data server that has received the information transmitted by the mobile beacon B_{M}, for example by implementing calculations by means of a calculator to reconstruct a position or a path of the mobile beacon B_{M} over a given time interval.

### Mobile Cart Embedding a Mobile Beacon

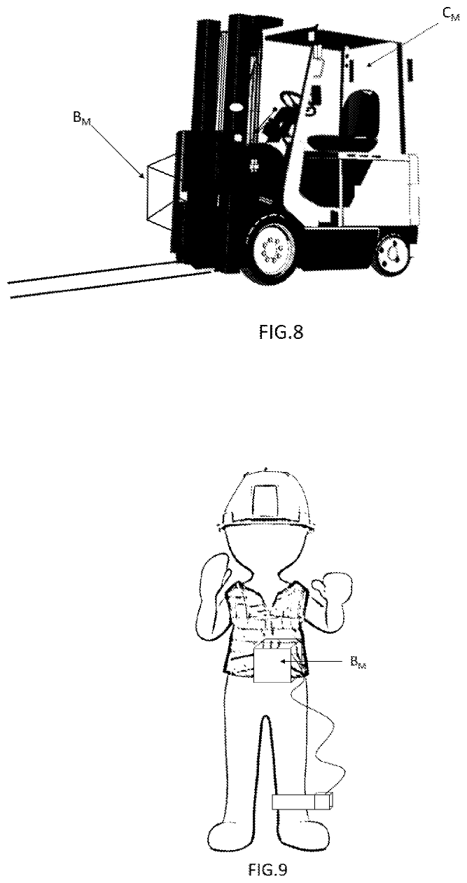

According to another aspect, with reference to FIG. 8, the invention relates to a mobile cart C_{M} embedding the mobile beacon B_{M} according to the invention and more generally any rolling object capable of moving and including a mobile beacon.

The mobile beacon B_{M} can be made integral with the mobile cart C_{M} by mechanical connection means. The mechanical connection means may comprise attachment elements such as screws, nuts, bolts where any other attachment element likely to make the mobile beacon B_{M} integral with said mobile cart C_{M}. In one alternative, the mobile cart comprises at least one rail and the mobile beacon comprises means of cooperation with said at least one rail, the mechanical cooperation of said at least one rail of the mobile cart C_{M} with the means of cooperation of the mobile beacon B_{M} resulting in a mechanical assembly securing the mobile beacon B_{M} to said mobile cart C_{M}. However, the elements included in the mechanical connection means are not limited to the aforementioned examples, and any mechanical element for securing the mobile beacon B_{M} to the mobile cart C_{M} may be included in the mechanical connection means. Advantageously, the risks of deteriorating the mobile beacon B_{M} when moving the mobile cart C_{M} are thus reduced.

In one embodiment, the mobile cart C_{M} embedding the mobile beacon B_{M} is a lifting and handling apparatus, such as a forklift. According to another example, the mobile cart C_{M} is a hand-operated pallet truck. In this example, the lifting and handling device includes a lifting system. The lifting system may comprise a plurality of elements such as a pulley, mast, hydraulic system, and forks. The lifting and handling apparatus may comprise an engine or motor compartment containing a motor such as an electric motor or an engine such as a heat engine. The lifting and handling apparatus may comprise a cabin intended for receiving a user of said lifting and handling apparatus. The cabin may include a steering wheel, seat, and means for controlling the lifting system. In this exemplary embodiment, the mobile beacon B_{M} made integral with the lifting and handling apparatus advantageously enables UWB tags affixed to objects such as parcels moved by said lifting and handling apparatus to be energized.

The mobile beacon B_{M} can be made integral with the lifting system of the mobile cart C_{M} by the mechanical connection means. This advantageously allows moving the mobile beacon B_{M} by moving the lifting system. This configuration is particularly advantageous when the mobile beacon B_{M} comprises a UHF transmitter and a UWB tag is affixed to a parcel located at height. The movement of the lifting system then allows the UHF source to be brought closer to the UWB tag to be supplied, to cause transmission of a UWB signal by said UWB tag. This configuration is particularly advantageous in the case of loading an object at height onto the moving part of the forklift. Indeed, the fact that the mobile beacon B_{M} is made integral with the mobile part of the cart allows detecting the object that the user is loading and therefore it is not necessary to wait until the mobile part has returned to its initial position to detect the loaded object.

According to one embodiment, the mobile beacon B_{M} and/or the mobile cart comprises a distance sensor. The distance sensor is configured to calculate a distance between the ground and the moving part of said mobile cart C_{M}. The distance sensor can be either an ultrasonic sensor or a laser range finder. However, the type of sensor used is not limited to the above examples and can include any type of distance sensor or a combination of several distance sensors. One advantage is to determine how far from the ground the mobile part of the forklift is when loading or unloading an object containing a UWB tag.

In one embodiment, the mobile cart C_{M} comprises a battery. The battery can be a battery for supplying both the mobile cart C_{M} and the mobile beacon B_{M} with electric energy. According to one alternative, the battery is only used to supply the mobile cart with electric energy. The mobile cart may also comprise audible and/or visual indicators. The audible and/or visual indicators are intended to warn a user of exceeding a predetermined charge level of said battery. This is particularly advantageous to warn a user of the need to recharge said battery to avoid system malfunction.

In one embodiment in which the battery supplies both the mobile cart C_{M} and the mobile beacon B_{M}, exceeding the predetermined charge level of the battery causes the power supply of the mobile beacon B_{M} to be interrupted by said battery. This advantageously makes it possible to save the remaining electric energy in the battery, for example to allow a user to use the remaining energy to approach a charging point such as a mains socket.

In one embodiment, the mobile cart C_{M} embedding the mobile beacon B_{M} may comprise a charging cradle. The charging cradle may comprise at least one electrical connector. The at least one electrical connector is configured to electrically connect to the battery of the mobile beacon B_{M}. Electrical connection between the charging cradle and the mobile beacon can be made, for example, via a plug and a socket. According to one embodiment, the charging cradle may advantageously be positioned at the lower part of the mobile cart C_{M}, at the lifting system. In this example, the connector of the cradle is configured to connect to the battery of the mobile beacon B_{M} via the at least one electrical connector when the mobile cart lifting system is in the lowered position and the mobile beacon is made integral with said lifting system of the mobile cart C_{M}. One advantage is that the battery of the mobile beacon B_{M} can be recharged when the lifting system of the mobile cart is not operated for loading or unloading an object. Another advantage is that there is no need for electrical cables connected to the battery of the mobile beacon B_{M}. In one alternative, the charging cradle includes an induction charger. The induction charger comprises, for example, a planar surface comprising a copper coil. However, any type of technology enabling the mobile beacon B_{M} to be charged by induction is likely to be implemented within the scope of the invention. According to one example, the mobile beacon B_{M} comprises a receiver compatible with the induction charger.

According to one embodiment, the mobile beacon B_{M} and/or the mobile cart C_{M} comprises light emitting means. The light emitting means may, for example, comprise a lamp, a headlight or any other electrically powered element configured to emit a light signal. The light emitting means can, for example, be powered by the battery of the mobile cart C_{M} or the mobile beacon B_{M}. One advantage is to be able to light the environment when moving the mobile cart C_{M} embedding the mobile beacon B_{M} or when loading an object by said mobile cart C_{M}.

In one embodiment, the mobile beacon B_{M} and/or the mobile cart C_{M} comprise video recording means. The video recording means may, for example, comprise a camera. The video recording means can for example be powered by the battery of the mobile beacon B_{M} or the mobile cart C_{M}. One advantage is to be able to associate an image or video sequence with timestamping of the reception of a UWB signal by the mobile beacon B_{M}. The images and/or video sequences acquired may, for example, be stored in the memory MEM of the mobile beacon B_{M}. This advantageously makes it possible to improve identification of the tags originating the transmission of the UWB signals received by the mobile beacon B_{M}, by obtaining a picture of said tags.

According to one embodiment, the mobile cart comprises a screen. For example, the screen is located in a user's cabin. In one embodiment, the screen is connected to the video recording means. One advantage is to allow a user to live track acquisition of video sequences by the video recording means. Another advantage is to be able to detect live a possible failure of said video recording means or even an anomaly when loading an object on the mobile cart C_{M}. In one embodiment, the mobile cart C_{M} embedding the mobile beacon B_{M} comprises a user interface. The user interface comprises, for example, a digital tablet comprising an internal memory. In one embodiment, the digital tablet comprises non-wired connection means for connecting to a piece of equipment of the data network. The non-wired connection means comprise, for example, a WI-FI, 3G, 4G, 5G or Bluetooth link. The digital tablet is connected to the mobile beacon via a wired or non-wired link. One advantage is to allow the mobile beacon to transmit part of the information contained in its memory MEM to the tablet. Another advantage is to allow a user to view the information contained in the memory of the mobile beacon B_{M} directly on the digital tablet. Data contained in the internal memory of the digital tablet can be sent to a piece of equipment of the data network NET via non-wired connection means. In one embodiment, the link between the user interface and the piece of equipment of the data network NET is bidirectional. One advantage is to be able to retrieve information recently stored on the piece of equipment of the data network NET by at least one other connected piece of equipment, for example another mobile beacon B_{M}.

According to one embodiment, the screen of the mobile cart C_{M} is configured to display contextual information. These are, for example, data measured by sensors, such as temperature data, data of the distance separating the mobile beacon B_{M} or the mobile cart C_{M} from an object in the environment. The contextual information displayed by the screen may also comprise information identifying a user. For example, the screen may comprise an interface through which a user identifies by means of a password. This information can then be stored in memory and possibly transmitted to third-party piece of equipment or a data network via a wireless link. Contextual information can also include a piece of data relating to the time the mobile cart C_{M} is occupied by a user, or a piece of information on the equipment state (sensor failure detected, battery charge rate).

The contextual information may also comprise the contextual piece of information associated with the first signal S_{UWB1}. Contextual information may also comprise information identifying an object transported by the mobile cart B_{M}, or identifying a recipient of the object transported on the mobile cart B_{M}. For example, this includes information on the nature of an object transported within a box on which a radio tag UWB is affixed, or an identification piece of information of a customer for whom the object transported by the mobile cart C_{M} is intended. In one example, the user interface displays several contextual pieces of information on the screen and displays an interface through which the user can confirm whether or not the information displayed is compliant. Contextual information and compliance validation can then be transmitted via a wireless link and by means of a communication interface, via a signal encoding these data. All this information can also be stored within a memory for transmission subsequently, or even for reading by another user.

According to one embodiment, the mobile beacon is associated with several pieces of equipment comprising screens. It is for example a fixed piece of equipment in the mobile cart, and a mobile piece of equipment such as a mobile tablet or smartwatch. For example, both screens are configured to display contextual information. Thus, advantageously, if the screen in the cabin displays a piece of information that requires verification, such as a loading problem, the user can exit the mobile cart and check whether the information are compliant or not by having access to display of the contextual information when they are outside the mobile cart. A piece of equipment comprising a display and associated with the mobile beacon may also be configured to transmit radio messages, such as UWB signals, for example to allow locating a user, or to allow correlation of the position of the user with that of the mobile beacon B_{M} or the mobile cart C_{M}. According to one example, a piece of equipment comprising a screen is configured to implement communication and/or location means, for example via wifi, Bluetooth, 4G or GNSS, to detect and associate with a mobile beacon B_{M} or a mobile cart C_{M} present in the proximity thereof. According to another example, a piece of equipment comprising a screen and associated with the mobile beacon B_{M} or the mobile cart C_{M} is configured to issue an alert when it detects a connection error with the mobile beacon B_{M} or with the mobile cart C_{M}. For example, this may be a case where the piece of equipment is paired with another mobile beacon B_{M} or another mobile cart C_{M} than the one it was configured to associate with. The alert can include an audible alert, an error message display, or even vibration.

According to one embodiment, the mobile beacon B_{M} and/or the mobile cart C_{M} is configured to associate with one or more pieces of equipment comprising a screen comprising the user interface.

According to one embodiment, the mobile beacon B_{M} and/or the mobile cart C_{M} is configured to associate with a piece of equipment comprising a screen and comprising sensors. The sensors include, for example, motion sensors, a compass or even a camera. The piece of equipment including a screen may also comprise an integrated location system. In this case, the contextual information includes, for example, both data received from sensors positioned on the mobile beacon B_{M} and/or on the mobile cart C_{M} and data received from sensors positioned on the piece of equipment comprising a screen and comprising sensors.

In one embodiment, the mobile beacon B_{M} embedded by the mobile cart C_{M} comprises shock detection means. The shock detection means may for example comprise a shock sensor or a vibration sensor. The shock detection means are configured to detect vibration or shock when moving the mobile cart C_{M} or the mobile part of said mobile cart C_{M}. In one embodiment, detection of a vibration or a shock causes a detection signal to be transmitted from the shock detection means to the memory MEM of the mobile beacon. The detection signal includes a piece of information about a shock or vibration detected by the shock detection means. Transmission of the detection signal can be “automated”. By “automated”, it is meant that transmission of the detection signal can be carried out automatically to the memory of the mobile beacon B_{M}, for example when a certain shock or vibration threshold is reached.

In one embodiment, the detection signal is associated with the first tag piece of data ET₁. One advantage is to detect whether an object on which a UWB tag is affixed has received a shock upon loading, unloading or transporting said object. In one alternative, detection of a shock or vibration by the shock detection means results in the activation of a visual and/or audible indicator. For example, the indicator can be triggered when the shock or vibration measured exceeds a predetermined threshold value. In one example, the predetermined threshold value is set by a user via the user interface. One advantage is to produce a piece of information and transmit it directly to a user if the mobile cart C_{M} and/or the mobile beacon B_{M} embedded has been potentially damaged by the shock or vibrations. The user may also advantageously be informed of a risk of loss of calibration of the mobile beacon B_{M} as a result of the shock experienced.

### Mobile Beacon Embedded by a User

According to another aspect illustrated in FIG. 9, the invention relates to an element embedded by a user including a mobile beacon B_{M} according to the invention. By “element embedded by a user”, it is meant that the position of the “embedded” element follows the position of the user embedding said element when said user moves. Thus, according to various examples, the embedded element comprises a strapped element such as a harness, an element comprising shoulder straps such as a backpack, an element including a handle such as a suitcase, a handheld scanner, or even an element strapped onto a body limb of a user such as their arm. More generally, any type of element that can be embedded, moved or transported by a user is likely to be implemented within the scope of the invention. In one alternative, the mobile beacon B_{M} is embedded by a user in a garment such as a vest comprising compartments for accommodating said mobile beacon B_{M}.

According to one embodiment, the mobile beacon B_{M} is embedded by a user by means for attaching said mobile beacon B_{M} to the user's body or garment. The attachment means may, for example, comprise a hook-and-loop fastener, or any other element allowing said mobile beacon B_{M} to be secured to a user's body part or garment.

In one embodiment, the embedded element comprises at least one sensor. According to various examples, the sensor comprises a pressure sensor or even a motion sensor. More generally, any type of sensor enabling a physical parameter to be measured in connection with the user, with the environment in which the user operates or even in connection with interactions of said user with their environment is likely to be implemented within the scope of the invention. One advantage is to be able to determine a physical piece of information to define the context, for example an odometric type piece of information to deduce that the mobile beacon B_{M} is in motion therefrom.

In one embodiment, the embedded element comprises at least one reading device. In one case, the reading device is configured to decode at least one piece of information from another device. According to one example, the reading device is configured to scan a piece of information stored in a quick response code, or even “QR code”. According to another example, the reading device comprises a radio frequency identification, or “RFID” reader.

According to one embodiment, the reading device is offset to a part of a user's body. According to one example, the reading device is offset to a user's lower limbs. Depending on different cases, the reading device comprises wired or non-wired connection means. One advantage is that be able to read information previously stored in the environment. Another advantage is to be able to locate a mobile beacon B_{M} more precisely.

According to another aspect, the invention relates to a system comprising a mobile beacon and at least one UWB radio tag.

According to one embodiment, the system comprises a plurality of UWB tags, the mobile beacon B_{M} according to the invention, and the location system L_{GEO}. The elements of the system may interact with each other to implement any of the embodiments of the method according to the invention.

In one embodiment, the system also comprises a mobile cart C_{M} embedding the mobile beacon B_{M} or any rolling object likely to move and including a mobile beacon. According to another example, the system comprises an element embedded by a user and the mobile beacon B_{M} according to the invention.

In all cases, the mobile beacon B_{M} included in the system is configured to implement any of the embodiments of the method according to the invention.

1. A method for transmitting a piece of information from at least one first Ultra-Wide Band (UWB) radio tag by means of a mobile beacon including transmission and reception means, the method comprising:
transmitting a first energizing signal by a transmitter of the mobile beacon;
receiving, by the mobile beacon, by means of a UWB receiver, a first UWB signal transmitted by the first UWB radio tag energized by said first energizing signal, said first UWB signal comprising a first tag piece of data;
time stamping said reception of the first UWB signal to produce a first timestamping piece of data associated with the first piece of data;
decoding the first tag piece of data and recording the first tag piece of data decoded in a memory of the mobile beacon;
associating a first position piece of data of the mobile beacon with said first tag piece of data, said position piece of data enabling the mobile beacon to be located, said first position piece of data being determined by means of a location system, and;
transmitting a first piece of information by the mobile beacon comprising said first tag piece of data and the first timestamping piece of data and transmitting a second piece of information by the mobile beacon including the first position piece of data to at least one piece of equipment of a data network.

2. The method according to claim 1, wherein the first piece of information is transmitted to a data server via a Wifi, 4G, 5G or Bluetooth link and the second piece of information is transmitted in the form of a UWB message to a location system comprising at least one fixed beacon comprising means for receiving UWB signals to calculate by trilateration a position of the mobile beacon, said association between the first position piece of data of the mobile beacon and said first tag piece of data being performed by the data server so as to allow locating said mobile beacon.

3. The method according to claim 2, comprising:
transmitting a plurality of second UWB signals by the mobile beacon by means of a UWB transmitter, each second UWB signal comprising at least one encoded piece of data of identifying said mobile beacon;
receiving the plurality of second UWB signals by the location system comprising a plurality of UWB radio beacons, said location system comprising radio reception means and means for decoding the identification piece of data and for timestamping arrival of the second UWB signal;
transmitting to the mobile beacon by the location system, a piece of information of detecting the second UWB signal, and
calculating, by means of the plurality of second signals received by each of the radio beacons, the first position piece of data of the mobile beacon.

4. The method according to claim 2, comprising:
transmitting a second UWB signal by the mobile beacon by means of a UWB transmitter, said second UWB signal comprising at least one encoded piece of data of identifying said mobile beacon, said transmitting causing activation of a clock to measure a first time interval, and
transmitting a plurality of second UWB signals at an increased frequency for a second time interval in case of non-reception of a detection piece of information at the end of a first time interval, said detection piece of information indicating detection of the second UWB signal by a UWB reception system.

5. The method according to claim 1, wherein the mobile beacon receives the first position piece of data transmitted by:
a reference tag having known position;
a satellite geolocation system;
a geolocation system by geocoder;
a Wi-Fi geolocation system;
a geolocation system by use of a telecommunications operator,
an RFID geolocation system.

6. The method according to claim 1, wherein the first piece of information and the second piece of information are transmitted to a data server by a wireless communication interface, and wherein the association between the first position piece of data and the first tag piece of data is made within the mobile beacon, said first position piece of data being transmitted to the mobile beacon by the location system.

7. The method according to claim 1, comprising:
receiving, by the mobile beacon and by means of a UWB receiver, a third UWB signal transmitted by at least one reference UWB radio tag having known position, said third UWB signal comprising a first time piece of information encoded of timestamping transmission of said third UWB signal and comprising a second encoded piece of data of identifying the reference UWB radio tag using a UWB receiver;
timestamping said reception of the third UWB signal to produce a second time stamping piece of data of the reception of the time piece of information and the second piece of data;
recording the first decoded time piece of information and the second decoded identification piece of data in a memory of the mobile beacon, and
transmitting, by the mobile beacon, a third piece of information comprising the first time piece of information, the second piece of data and the second timestamping data to at least one piece of equipment of the data network.

8. The method according to claim 7, comprising:
transmitting, by the mobile beacon and by a plurality of UWB radio beacons, a plurality of third pieces of information by means of a communication interface and to at least one piece of equipment of the data network;
calculating, for the mobile beacon and for each UWB radio beacon and by means of a calculator, a time piece of information of propagating every third UWB signal, each propagation time piece of information being calculated from each first time piece of information and each second timestamping piece of data;
comparing, by a comparator, the time information of propagating every third UWB signal, and
synchronizing a clock of the mobile beacon and a clock of each UWB radio beacon with each other according to the result of the comparisons of the propagation time information.

9. The method according to claim 1, comprising implementing, by means of a calculator, at least one calculation by trilateration of a relative position of the first UWB radio tag, from the first UWB signal transmitted by said first UWB radio tag and received by the mobile beacon and by at least two other UWB radio beacons.

10. The method according to claim 1, comprising:
receiving a first amount of Ultra-High Frequency (UHF) energy by the mobile beacon by means of a UHF receiver;
comparing the first amount of UHF energy received with a predetermined threshold energy value by means of a comparator;
transmitting the first energizing signal by means of the transmitter of the mobile beacon if the first amount of UHF energy received is less than the predetermined threshold energy value;
reducing the energy transmitted by the transmitter of the mobile beacon if the first amount of UHF energy received is greater than the predetermined threshold energy value.

11. The method according to claim 1, comprising:
measuring a distance value between an object and the mobile beacon by means of a distance sensor;
comparing, by means of a comparator, the distance value measured with a predetermined threshold distance value (V_{threshold});
modulating the transmission of the first energizing signal by the UHF transmitter of the mobile beacon if the distance value measured is less than the predetermined threshold distance value.

12. The method according to claim 1, wherein the first UWB signal received by the mobile beacon is associated with a context piece of information corresponding to a piece of information on the environment in which the mobile beacon operates, and wherein the first piece of information transmitted to the equipment of a data network comprises the context piece of information, the context piece of information being processed by processing means to determine an identification piece of data of the mobile beacon having transmitted the first energizing signal originating transmission by the first UWB radio tag of said first UWB signal received by said mobile beacon.

13. A mobile beacon comprising means for transmitting an energizing signal, means for receiving UWB signals, a calculator and a memory, wherein the mobile beacon is configured to implement the method of claim 1.

14. The mobile beacon according to claim 13, comprising at least two transmission antennas, each transmission antenna being configured to transmit at least one portion of the first energizing signal.

15. A mobile cart comprising a mobile beacon according to claim 13.

16. An element embedded by a user including a mobile beacon according to claim 13.

17. A system comprising a mobile beacon according to claim 13 and comprising at least one first UWB radio tag configured to transmit the first UWB signal.
